(19) United States
(12) Patent Application Publication
(10) Pub. No.: US 2012/0091901 A1
(43) Pub. Date: Apr. 19, 2012

(54) ILLUMINATION DEVICE

(75) Inventors: Tetuya TANIGAWA, Kobe-shi (JP); Kazufumi Nagazoe, Sakai-shi (JP)

(73) Assignee: Panasonic Electric Works Co., Ltd., Osaka (JP)

(21) Appl. No.: 13/271,405

(22) Filed: Oct. 12, 2011

(30) Foreign Application Priority Data
Oct. 13, 2010 (JP) 2010-230875

(51) Int. Cl. H05B 37/02

(52) U.S. Cl. 315/158

(57) ABSTRACT

An illumination device, includes: a photovoltaic power generation unit; a battery unit for storing the electric power generated in the photovoltaic power generation unit; a light source to be turned on using the battery unit as a power source; a human detecting sensor; a human determining unit for determining presence/absence of the human based on a detection result of the human detecting sensor; a season determining unit; and a lighting control unit for, if the human determining unit determines that the human exists, turning on the light source at a specified dimming rate for a specified on-duration. The lighting control unit is configured to, based on a season determination result of the season determining unit, make power consumption of the light source in a season having a reduced daytime period smaller than power consumption of the light source in a season having an increased daytime period.

### FIELD OF THE INVENTION

The present invention relates to an illumination device.

### BACKGROUND OF THE INVENTION

There is conventionally available an illumination device for streetlamps or the like using photovoltaic power generation (see, e.g., Japanese Patent Application Publication No. 2006-236584). The illumination device of this kind includes a solar cell and a battery. The electric power generated by the solar cell is charged to the battery. Light sources are turned on using the electric power charged to the battery as a power source. The illumination device further includes a human detecting sensor for detecting presence/absence of a human. If the presence of a human is detected by the human detecting sensor, the light sources are turned on for a predetermined time at a specified dimming rate.

The power generation amount of a solar cell, i.e., the electric power charged to a battery, varies with the seasons. In summer, the power generation amount is increased because the daytime becomes longer. In winter, however, the power generation amount gets smaller than in summer because the daytime becomes shorter. Further, since the nighttime is long in winter, it is necessary to turn on light sources for a long period of time. For that reason, there is a concern that the electric power required to turn on the light sources may run short in winter.

### SUMMARY OF THE INVENTION

In view of the above, the present invention provides an illumination device capable of controlling power consumption of a light source depending on the seasons.

In accordance with one aspect of the present invention, there is provided an illumination device, comprising: a photovoltaic power generation unit for receiving sunlight and generating electric power; a battery unit for storing the electric power generated in the photovoltaic power generation unit; a light source to be turned on using the battery unit as a power source; a human detecting sensor for detecting a human; a human determining unit for determining presence/absence of the human based on a detection result of the human detecting sensor; a season determining unit for determining a present season; and a lighting control unit for, if the human determining unit determines that the human exists, turning on the light source at a specified dimming rate for a specified on-duration. The lighting control unit is configured to, based on a season determination result of the season determining unit, make power consumption of the light source in a season having a reduced daytime period smaller than power consumption of the light source in a season having an increased daytime period.

The lighting control unit may be configured to, based on the season determination result of the season determining unit, make the on-duration in the season having the reduced daytime period shorter than the on-duration in the season having the increased daytime period.

Further, the lighting control unit may be configured to, based on the season determination result of the season determining unit, make the dimming rate in the season having the reduced daytime period lower than the dimming rate in the season having the increased daytime period.

Preferably, the human determining unit may be configured to determine that the human exists if the human detecting sensor detects the human for a specified determination duration, and wherein the human determining unit is configured to, based on the season determination result of the season determining unit, make the determination duration in the season having the increased daytime period shorter than the determination duration in the season having the reduced daytime period.

The illumination device may further comprises a power generation amount detecting unit for detecting an amount of the electric power generated by the photovoltaic power generation unit, the season determining unit being configured to determine the season, based on a detection result of the power generation amount detecting unit.

In addition, the illumination device may further comprises a time measuring unit having a time measuring function, the season determining unit being configured to determine the season based on a time measuring result of the time measuring unit.

The illumination device may further comprises a brightness sensor for detecting illuminance in an outdoor area, the season determining unit being configured to measure an accumulated period of time during which the illuminance detected by the brightness sensor is kept equal to or greater than a specified threshold value, the season determining unit being configured to determine the season based on the accumulated period of time.

In accordance with another aspect of the present invention, there is provided an illumination apparatus comprising the illumination device described in the one aspect of the present invention.

With the present invention summarized above, there is provided an effect that the power consumption of a light source can be controlled depending on the seasons.

### BRIEF DESCRIPTION OF THE DRAWINGS

The objects and features of the present invention will become apparent from the following description of embodiments, given in conjunction with the accompanying drawings, in which:

FIG. 1 is a block diagram showing an illumination device according to one embodiment of the present invention;

FIG. 2 is a block diagram of a power generation amount detecting unit employed in the illumination device;

FIG. 3 is a block diagram of another power generation amount detecting unit employed in the illumination device;

FIG. 4 is a graph representing a power generation amount in the illumination device;

FIG. 5 is a waveform diagram of a human detection signal generated in the illumination device;

FIG. 6 is a waveform diagram of another human detection signal generated in the illumination device;

FIG. 7 is a graph representing a dimming rate of a light source employed in the illumination device;

FIG. 8 is a graph representing another dimming rate of a light source employed in the illumination device;

FIG. 9 is a block diagram showing a modified example of the illumination device;

FIG. 10 is a block diagram showing another modified example of the illumination device; and

FIG. 11 is a schematic view illustrating the outward appearance of the illumination device.

### DETAILED DESCRIPTION OF THE PREFERRED EMBODIMENTS

One preferred embodiment of the present invention will now be described with reference to the accompanying drawings which form a part hereof.

### Embodiment

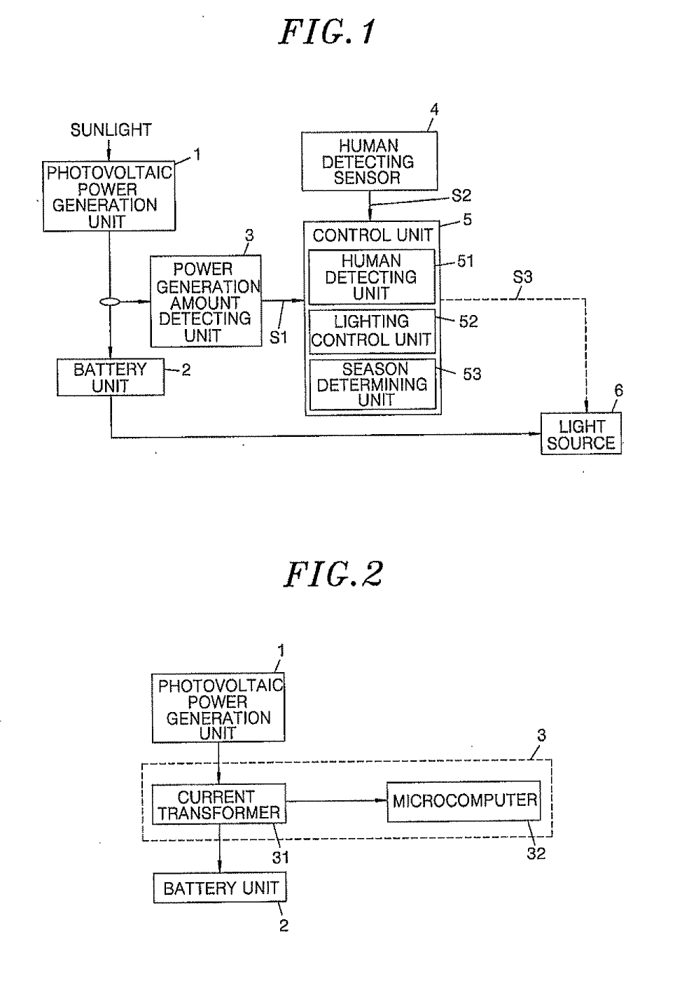

FIG. 1 is a block diagram showing an illumination device according to one embodiment of the present invention. The illumination device of the present embodiment includes a photovoltaic power generation unit 1, a battery unit 2, a power generation amount detecting unit 3, a human detecting sensor 4, a control unit 5, and a light source 6.

The configurations of the respective components will be described herein below.

The photovoltaic power generation unit 1 includes a solar cell and is designed to generate electric power by receiving the sunlight. The photovoltaic power generation unit 1 supplies the generated electric power to the battery unit 2, whereby the battery unit 2 is charged with the electric power.

The power generation amount detecting unit 3 detects the power generation amount in the photovoltaic power generation unit 1 and outputs the detection result to the control unit 5. As shown in FIG. 2, the power generation amount detecting unit 3 includes a current transformer 31 and a microcomputer 32.

The current transformer 31 detects an electric current flowing through an electric circuit interconnecting the photovoltaic power generation unit 1 and the battery unit 2, i.e., an electric current supplied from the photovoltaic power generation unit 1 to the battery unit 2, and outputs the detection result to the microcomputer 32. The microcomputer 32 functions as an A/D converter unit and converts the detection result outputted from the current transformer 31 as an analog value to a digital signal. With this configuration, the power generation amount detecting unit 3 detects the power generation amount in the photovoltaic power generation unit 1 by detecting the output current of the photovoltaic power generation unit 1, generates a power generation amount detection signal S1 as a digital signal and transmits the power generation amount detection signal S1 to the control unit 5.

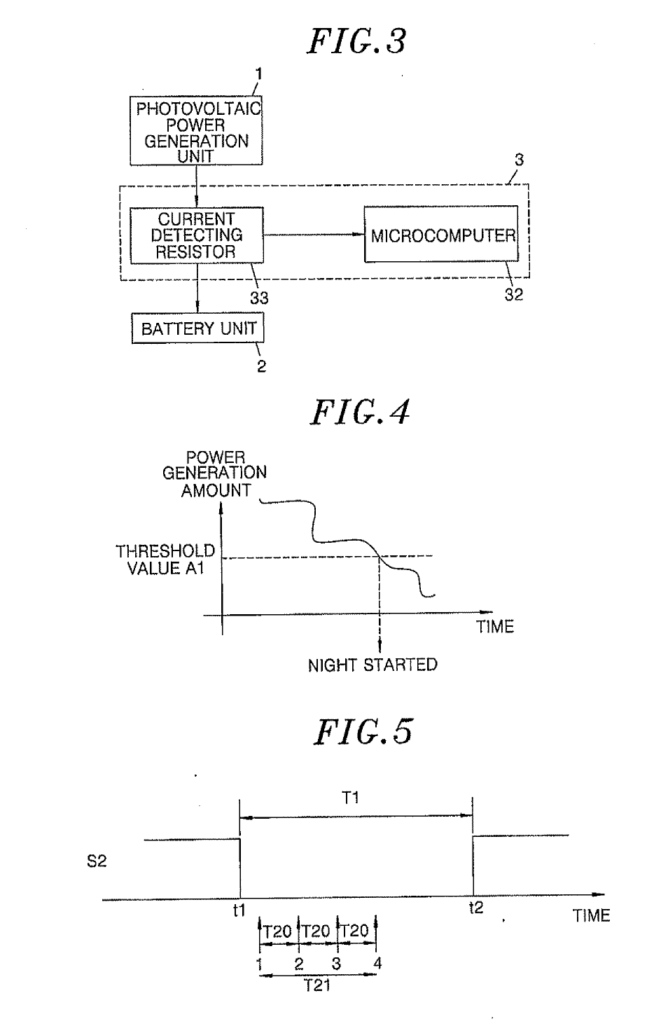

As shown in FIG. 3, a current detecting resistor 33 may be used in place of the current transformer 31. The current detecting resistor 33 is serially connected to the electric circuit interconnecting the photovoltaic power generation unit 1 and the battery unit 2. The microcomputer 32 detects the voltage between the opposite ends of the current detecting resistor 33. By A/D converting the detected voltage, the microcomputer 32 generates a power generation amount detection signal S1 and transmits the signal S1 to the control unit 5.

The human detecting sensor 4 is formed of a pyroelectric infrared detecting element (pyroelectric infrared element). The human detecting sensor 4 detects infrared rays (heat) radiated from a human in a specified detection area, namely, a temperature difference between a human and a background thereof. The human detecting sensor 4 detects the human by detecting the temperature difference. The human detecting sensor 4 generates a human body detection signal S2 indicating the presence/absence of a human in the detection area and transmits the human body detection signal S2 to the control unit 5.

The control unit 5 is formed of a microcomputer and so forth. The control unit 5 includes a human determining unit 51, a lighting control unit 52 and a season determining unit 53.

The human determining unit 51 determines the presence/absence of a human in the detection area based on the human body detection signal S2 transmitted from the human detecting sensor 4.

The lighting control unit 52 generates a dimming signal S3 based on the day-night determination result pursuant to the power generation amount detection signal S1 transmitted from the power generation amount detecting unit 3 and the determination result of the presence/absence of a human obtained by the human determining unit 51. The dimming signal S3 is formed of, e.g., a PWM signal. The lighting control unit 52 transmits the dimming signal S3 to the light source 6, thereby controlling the lighting of the light source 6.

The season determining unit 53 determines the current season based on the power generation amount detection signal S1 transmitted from the power generation amount detecting unit 3.

The battery unit 2 is used as a power source of the light source 6. The light source 6 is turned on as the electric power charged to the battery unit 2 is supplied thereto. The light source 6 includes a lighting circuit. The light source 6 is turned on, turned off and dimmed in response to the dimming signal S3 transmitted from the lighting control unit 52. The light source 6 may be a discharge lamp, and LED, an incandescent lamp or the like. The kind of the light source 6 is not particularly limited.

Description will now be made on the detailed operations of the respective components of the illumination device according to the present embodiment.

FIG. 4 is a graph representing the power generation amount of the photovoltaic power generation unit 1.

The season determining unit 53 determines the current season based on the power generation amount indicated by the power generation amount detection signal S1. A threshold value A1 relating to the power generation amount is pre-set in the season determining unit 53. The season determining unit 53 includes a timer for measuring the time. The time during which the power generation amount is equal to or greater than the threshold value A1 is regarded as the daytime. The time during which the power generation amount is smaller than the threshold value A1 is regarded as the nighttime. The timer measures the accumulated durations of the daytime and the nighttime to calculate a daytime period and a nighttime period. The season determining unit 53 determines the current season from the percentages of the daytime period and the nighttime period in 24 hours.

In other words, the season determining unit 53 determines the sun-existing daytime and the sun-disappearing nighttime from the 24-hour change of the power generation amount of the photovoltaic power generation unit 1. In summer, the daytime period is longer and the nighttime period is shorter. In winter, the daytime period is shorter and the nighttime period is longer. Accordingly, the season determining unit 53 can determine the current season from the percentages of the daytime period and the nighttime period in 24 hours. For example, the season determining unit 53 determines the season to be winter if the daytime period is less than 11 hours, spring or autumn if the daytime period is equal to or greater than 11 hours and less than 13 hours, and summer if the daytime period is equal to or greater than 13 hours.

Next, description will be given on the human determining unit 51.

The human determining unit 51 determines the presence/absence of a human in the detection area based on the human body detection signal S2 transmitted from the human detecting sensor 4. FIG. 5 shows a waveform diagram of the human body detection signal S2.

Upon detecting infrared rays (a temperature difference) radiated from a human at the time t1, the human detecting sensor 4 changes the output level of the human body detection signal S2 from the high level to the low level. If a human is not detected at the time t2, the human detecting sensor 4 changes the output level of the human body detection signal S2 from a low level to a high level. That is, the human detecting sensor 4 makes the output level of the human body detection signal S2 be the low level if a human is detected. The human detecting sensor 4 makes the output level of the human body detection signal S2 be the high level if a human is not detected. In the present embodiment, the duration during which a human is detected by the human detecting sensor 4 (the time period from the time t1 to the time t2) is referred to as human-detecting duration T1.

The human determining unit 51 detects the output level of the human body detection signal S2 every T20 (10 ms). The human determining unit 51 determines that a human exists in the detection area if it detects the “low” output level of the human body detection signal S2 four times in succession as shown in FIG. 5. The duration from the first detection of the “low” output level of the human body detection signal S2 to the fourth detection the “low” output level of the human body detection signal S2 is referred to as determination duration T21. If the human-detecting duration T1 is longer than the determination duration T21 no matter how short the human-detecting duration T1 may be, the human determining unit 51 determines that a human exists in the detection area. This enables the human determining unit 51 to detect the presence/absence of a human in a reliable manner and to avoid erroneous detection.

Since the human detecting sensor 4 of the present embodiment is formed of a pyroelectric infrared detecting element, the accuracy of detection is reduced in summer when the temperature difference between a human and a background thereof becomes small.

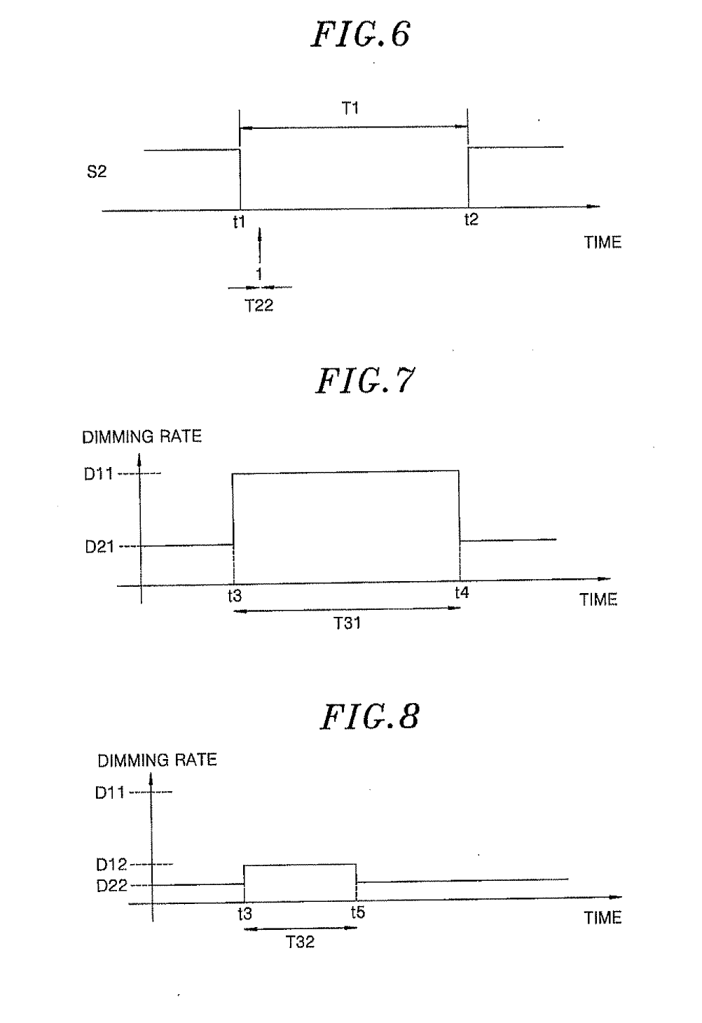

In view of this, when the season determining unit 53 determines the season to be summer, the human determining unit 51 of the present embodiment determines that a human exists in the detection area if it detects the “low” output level of the human body detection signal S2 even once as illustrated in FIG. 6. That is, if the season is determined to be summer, the human determining unit 51 uses a determination duration T22 shorter than the determination duration T21. The determination duration T22 is a time period required for the human determining unit 51 to detect the output level of the human body detection signal S2. By shortening the determination duration for determination of the presence/absence of a human in summer when the accuracy of detection of the human detecting sensor 4 is reduced, it is possible to prevent the human determining unit 51 from erroneously determining the presence of a human to be the absence of a human.

While the human determining unit 51 of the present embodiment detects the output level of the human body detection signal S2 every 10 ms, the present invention is not limited thereto. While the human determining unit 51 determines the presence of a human by detecting the “low” output level of the human body detection signal S2 four times in succession in winter, spring and autumn and once in summer, the present invention is not limited thereto.

Next, description will be made on the lighting control unit 52.

The lighting control unit 52 controls the lighting of the light source 6 based on the day-night determination result pursuant to the power generation amount detection signal S1, the determination result of the presence/absence of a human obtained by the human determining unit 51 and the determination result of the season obtained by the season determining unit 53.

The lighting control unit 52 monitors the power generation amount indicated by the power generation amount detection signal S1. If the power generation amount is equal to or greater than the threshold value A1, the lighting control unit 52 determines the present time to be the daytime and turns off the light source 6. If the power generation amount is less than the threshold value A1, the lighting control unit 52 determines the present time to be the nighttime and turns on the light source 6. At this time, the lighting control unit 52 decides a dimming rate of the light source 6 based on the determination result of the detecting unit 6. If the human determining unit 51 determines that a human is absent, the lighting control unit 52 turns on the light source 6 at a second dimming rate D2. 6. If the human determining unit 51 determines that a human exists, the lighting control unit 52 turns on the light source 6 at a first dimming rate D1 higher than the second dimming rate D2 for a predetermined on-duration T3. After the on-duration T3 lapses, the lighting control unit 52 secondly decides the dimming rate of the light source 6 based on the determination result of the human determining unit 51. In this manner, the lighting control unit 52 of the present embodiment turns on the light source 6 at night and increases the dimming rate of the light source 6 if a human exists in the detection area.

The lighting control unit 52 changes the first dimming rate, the second dimming rate and the on-duration based on the determination result of the season determining unit 53.

Referring to FIG. 7, if the season determining unit 53 determines the season to be summer, the lighting control unit 52 sets the first dimming rate D1 equal to D11 (100%), the second dimming rate D2 equal to D21 (25%), and the on-duration T3 equal to T31 (3 minutes).

If the present time is determined to be the nighttime, the lighting control unit 52 turns on the light source 6. Prior to the time t3, the human determining unit 51 determines that a human is absent and the lighting control unit 52 turns on the light source 6 at the second dimming rate D21 (25%). If the human determining unit 51 determines that a human exists at the time t3, the lighting control unit 52 turns on the light source 6 at the first dimming rate D11 (100%) for the on-duration T31 (3 minutes). After the time t4, namely after the on-duration T31 (3 minutes) lapses from the time t3, the lighting control unit 52 turns on the light source 6 at the second dimming rate D21 (25%) again if the human determining unit 51 determines that no human exists at the time t4.

The setting mentioned above does not matter in summer when the daytime period is long and the electric power charged to the battery unit 2 is high. In winter, however, the daytime period is shorter than in summer and the electric power charged to the battery unit 2 is lower than in summer. Further, since the nighttime period is long in winter, there is a need to turn on the light source 6 for a long period of time. For that reason, there is a possibility that the electric power for turning on the light source 6 may become insufficient in winter among other seasons. Therefore, a need exists to make the power consumption of the light source 6 smaller in winter, spring and autumn than in summer.

Referring to FIG. 8, if the season determining unit 53 determines the season to be winter, the lighting control unit 52 sets the first dimming rate D1 equal to D12 (20%), the second dimming rate D2 equal to D22 (5%), and the on-duration T3 equal to T32 (1 minute).

If the present time is determined to be the nighttime, the lighting control unit 52 turns on the light source 6. Prior to the time t3, the human determining unit 51 determines that a human is absent and the lighting control unit 52 turns on the light source 6 at the second dimming rate D22 (5%). If the human determining unit 51 determines that a human exists at the time t3, the lighting control unit 52 turns on the light source 6 at the first dimming rate D12 (20%) for the on-duration T32 (1 minutes). After the time t5, namely after the on-duration T32 lapses from the time t3, the lighting control unit 52 turns on the light source 6 at the second dimming rate D22 (5%) again if the human determining unit 51 determines that no human exists at the time t5.

In this manner, the lighting control unit 52 makes the first and second dimming rates D1 and D2 lower in winter than in summer and keeps the on-duration T3 shorter in winter than in summer if the season determining unit 53 determines the season to be winter. Thus, the first and second dimming rates D1 and D2 of the light source 6 are lower in winter than in summer and the on-duration T3 during which the light source 6 is turned on at the first dimming rate D1 with increased power consumption becomes shorter in winter than in summer. This helps reduce the power consumption of the light source 6. Accordingly, it is possible to prevent shortage of the electric power needed to turn on the light source 6 in winter.

If the season determining unit 53 determines the season to be spring or autumn, the lighting control unit 52 sets the on-duration T3 equal to 2 minutes between the on-duration T31 (3 minutes) and the on-duration T32 (1 minute). In addition, if the season determining unit 53 determines the season to be spring or autumn, the lighting control unit 52 sets the first dimming rate D1 equal to a value between the dimming rate D11 (100%) and the dimming rate D12 (20%) and sets the second dimming rate D2 equal to a value between the dimming rate D21 (25%) and the dimming rate D22 (5%). This makes it possible to reduce the power consumption of the light source 6 in the season when the daytime period from the sunrise to the sunset is short.

In summer when the temperature difference between a human and a background thereof becomes small, there is a possibility that, when the human determining unit 51 secondly determines the presence/absence of a human after the lapse of the on-duration T3, the human may not be detected despite the presence thereof. In such an instance, the dimming rate of the light source 6 is changed from the first dimming rate D11 to the second dimming rate D21, which results in the light source 6 becoming darker. However, the lighting control unit 52 of the present embodiment sets the on-duration T3 longer in summer than in winter if the season determining unit 53 determines the season to be summer. This can reduce the possibility that the light source 6 becomes darker regardless of the presence of a human.

In summer, the dimming rate of the light source 6 is kept as high as 25% even when the human determining unit 51 determines that a human is absent. Accordingly, it is possible to secure the intensity of illuminance within the irradiation range of the light source 6, which assists in enhancing the safety.

The specific values of the first and second dimming rates D1 and D2 and the on-duration T3 are not limited to the ones set forth above. For example, it may be possible to employ a configuration in which the second dimming rate D2 is set equal to 100% (a fully turned-on state) in summer and the light source 6 is fully turned on at night regardless of the determination result of the human determining unit 51. It may also be possible to employ a configuration in which the second dimming rate D2 is set equal to 0% (a turned-off state) in winter and the light source 6 is turned off if the human determining unit 51 determines that a human is absent.

In the present embodiment, the threshold value A1 is equally set in the lighting control unit 52 and the season determining unit 53. Alternatively, different threshold values may be set in the lighting control unit 52 and the season determining unit 53.

In the present embodiment, the lighting control unit 52 changes both the first and second dimming rates D1 and D2 and the on-duration T3 based on the determination result of the season determining unit 53. Alternatively, only one of the first and second dimming rates D1 and D2 and the on-duration T3 may be changed.

In the present embodiment, the season determining unit 53 determines the seasons and the lighting control unit 52 determines the daytime and the nighttime, based on the power generation amount of the photovoltaic power generation unit 1 indicated by the power generation amount detection signal S1 transmitted from the power generation amount detecting unit 3.

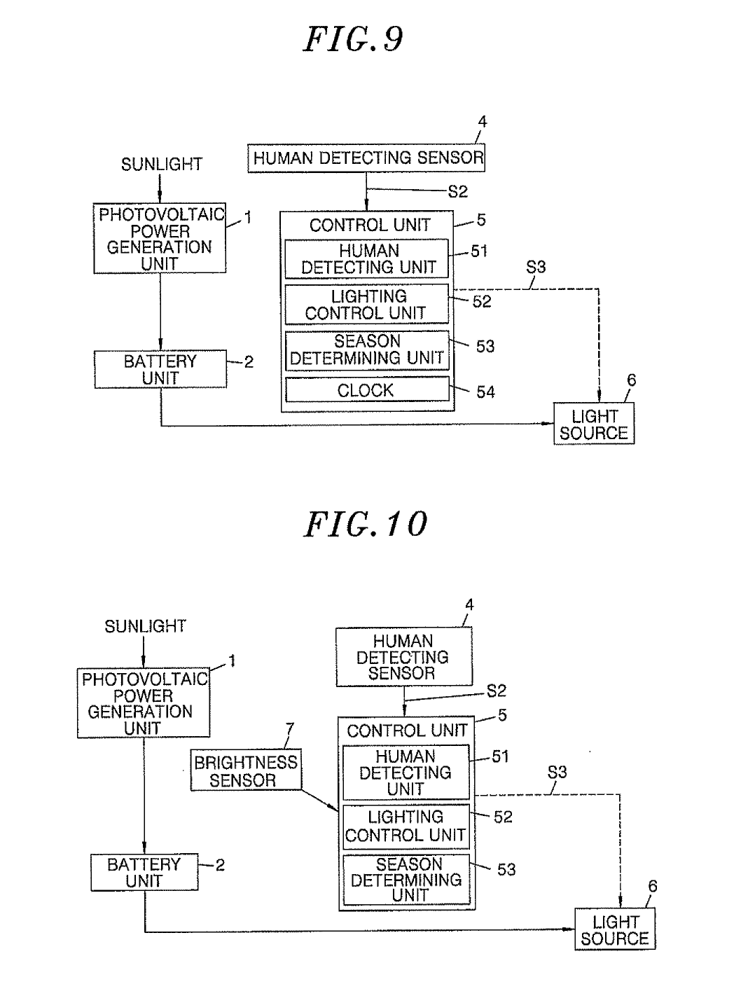

Alternatively, as shown in FIG. 9, the control unit 5 may be provided with a clock 54 (a time measuring unit) having a time measuring function in place of the power generation amount detecting unit 3. In this case, the season determining unit 53 determines the seasons depending on the current date indicated by the clock 54. The lighting control unit 52 determines the daytime and the nighttime depending on the current date and time indicated by the clock 54.

As illustrated in FIG. 10, a brightness sensor 7 may be provided in place of the power generation amount detecting unit 3. The brightness sensor 7 is formed of a photodiode or the like and is designed to detect the intensity of illumination around the illumination device (in the outdoor area). An illuminance threshold value is pre-set in the season determining unit 53. If the detection result of the brightness sensor 7 is equal to or greater than the illuminance threshold value, the season determining unit 53 determines the present time to be the daytime. If the detection result of the brightness sensor 7 is less than the illuminance threshold value, the season determining unit determines the present time to be the nighttime. The season determining unit 53 determines the seasons from the percentages of the accumulated time periods of the daytime and the nighttime. An illuminance threshold value is pre-set in the lighting control unit 52. If the detection result of the brightness sensor 7 is less than the illuminance threshold value, the lighting control unit 52 determines the present time to be the nighttime and turns on the light source 6.

In the present embodiment, the human detecting sensor is formed of a pyroelectric infrared detecting element. Alternatively, the human detecting sensor 4 may be formed of an ultrasonic sensor or an image sensor using a camera.

If the human detecting sensor 4 is formed of an ultrasonic sensor, the ultrasonic sensor transmits an ultrasonic signal and receives the reflective wave thereof. The human determining unit 51 determines the presence/absence of a human in the detection area based on the time difference between the transmission of the ultrasonic signal and the reception of the reflective wave.

If the human detecting sensor 4 is formed of an image sensor, the image sensor takes an image of the detection area. The human determining unit 51 processes the image thus taken and determines the presence/absence of a human in the detection area.

In case where the human detecting sensor 4 is made of a pyroelectric infrared detecting element, the human detection accuracy is affected by the seasons. However, the detection accuracy of the ultrasonic sensor and the image sensor is not affected by the seasons. Accordingly, if the human detecting sensor 4 is formed of the ultrasonic sensor or the image sensor, the determination duration for the human determining unit 51 to determine the presence/absence of a human needs not be changed depending on the seasons. This makes it possible to simplify the control of the human determining unit 51.

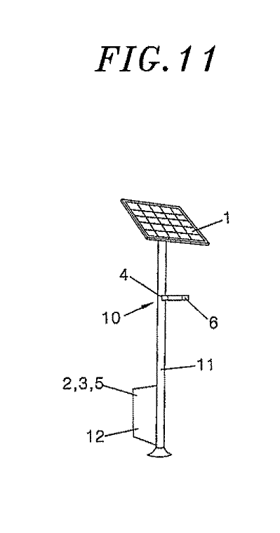

The illumination device of the present embodiment is used in an illumination apparatus (e.g., a streetlamp 10 illustrated in FIG. 11). The photovoltaic power generation unit 1 is arranged in the upper portion of a post 11. The battery unit 2 and the power generation amount detecting unit 3 are arranged within a housing 12 provided in the lower portion of the post 11. The human detecting sensor 4 and the light source 6 are arranged in the post 11. If the streetlamp 10 installed in an outdoor area is configured using the illumination device of the present embodiment, it is possible to reduce the power consumption of the light source 6 in winter by reducing the first and second dimming rates and shortening the on-duration as the daytime period determined by the season determining unit 53 becomes shorter. This can prevent the possibility that the electric power needed to turn on the light source 6 becomes insufficient in winter.

While the invention has been shown and described with respect to the embodiments, it will be understood by those skilled in the art that various changes and modification may be made without departing from the scope of the invention as defined in the following claims.

What is claimed is:

1. An illumination device, comprising:
a photovoltaic power generation unit for receiving sunlight and generating electric power;
a battery unit for storing the electric power generated in the photovoltaic power generation unit;
a light source to be turned on using the battery unit as a power source;
a human detecting sensor for detecting a human;
a human determining unit for determining presence/absence of the human based on a detection result of the human detecting sensor;
a season determining unit for determining a present season; and
a lighting control unit for, if the human determining unit determines that the human exists, turning on the light source at a specified dimming rate for a specified on-duration, the lighting control unit being configured to, based on a season determination result of the season determining unit, make power consumption of the light source in a season having a reduced daytime period smaller than power consumption of the light source in a season having an increased daytime period.

2. The illumination device of claim 1, wherein the lighting control unit is configured to, based on the season determination result of the season determining unit, make the on-duration in the season having the reduced daytime period shorter than the on-duration in the season having the increased daytime period.

3. The illumination device of claim 1, wherein the lighting control unit is configured to, based on the season determination result of the season determining unit, make the dimming rate in the season having the reduced daytime period lower than the dimming rate in the season having the increased daytime period.

4. The illumination device of claim 2, wherein the lighting control unit is configured to, based on the season determination result of the season determining unit, make the dimming rate in the season having the reduced daytime period lower than the dimming rate in the season having the increased daytime period.

5. The illumination device of claim 1, wherein the human determining unit is configured to determine that the human exists if the human detecting sensor detects the human for a specified determination duration, and
wherein the human determining unit is configured to, based on the season determination result of the season determining unit, make the determination duration in the season having the increased daytime period shorter than the determination duration in the season having the reduced daytime period.

6. The illumination device of claim 2, wherein the human determining unit is configured to determine that the human exists if the human detecting sensor detects the human for a specified determination duration, and
wherein the human determining unit is configured to, based on the season determination result of the season determining unit, make the determination duration in the season having the increased daytime period shorter than the determination duration in the season having the reduced daytime period.

7. The illumination device of claim 3, wherein the human determining unit is configured to determine that the human exists if the human detecting sensor detects the human for a specified determination duration, and
wherein the human determining unit is configured to, based on the season determination result of the season determining unit, make the determination duration in the season having the increased daytime period shorter than the determination duration in the season having the reduced daytime period.

8. The illumination device of claim 4, wherein the human determining unit is configured to determine that the human exists if the human detecting sensor detects the human for a specified determination duration, and
wherein the human determining unit is configured to, based on the season determination result of the season determining unit, make the determination duration in the season having the increased daytime period shorter than the determination duration in the season having the reduced daytime period.

9. The illumination device of claim 1, further comprising:
a power generation amount detecting unit for detecting an amount of the electric power generated by the photovoltaic power generation unit, the season determining unit being configured to determine the season, based on a detection result of the power generation amount detecting unit.

10. The illumination device of claim 1, further comprising:
a time measuring unit having a time measuring function, the season determining unit being configured to determine the season based on a time measuring result of the time measuring unit.

11. The illumination device of claim 1, further comprising:
a brightness sensor for detecting illuminance in an outdoor area, the season determining unit being configured to measure an accumulated period of time during which the illuminance detected by the brightness sensor is kept equal to or greater than a specified threshold value, the season determining unit being configured to determine the season based on the accumulated period of time.

12. An illumination apparatus comprising the illumination device described in claim 1.
